(19) United States
(12) Patent Application Publication
(10) Pub. No.: US 2024/0238674 A1
(43) Pub. Date: Jul. 18, 2024

(54) INFORMATION STORAGE MEDIUM, INFORMATION PROCESSING DEVICE, AND INFORMATION PROCESSING METHOD

(71) Applicant: CYGAMES, INC., Tokyo (JP)

(72) Inventor: Kazuya Matsunaga, Tokyo (JP)

(73) Assignee: CYGAMES, INC., Tokyo (JP)

(21) Appl. No.: 18/620,817

(22) Filed: Mar. 28, 2024

Related U.S. Application Data
(63) Continuation of application No. PCT/JP22/36475, filed on Sep. 29, 2022.

(30) Foreign Application Priority Data
Sep. 30, 2021 (JP) 2021-160682

(51) Int. Cl. A63F 13/5258; A63F 13/56

(52) U.S. Cl. CPC A63F 13/5258; A63F 13/56

(57) ABSTRACT

A non-transitory computer-readable information storage medium stores a program, an information processing device, and an information processing method capable of generating an image with high visibility. Every time a frame is updated, and arrangement of objects is thus updated, one enemy character is set as a top-priority target on the basis of an input from a player and the position relationship between the player's character and the enemy character, and correction processing is performed for correcting at least one of the position and the orientation of the virtual camera such that the top-priority target is automatically displayed.

### CROSS-REFERENCE TO RELATED APPLICATIONS

This application is a continuation of International Patent Application No. PCT/JP2022/036475, having an international filing date of Sep. 29, 2022, which designated the United States, the entirety of which is incorporated herein by reference. Japanese Patent Application No. 2021-160682 filed on Sep. 30, 2021 is also incorporated herein by reference in its entirety.

### BACKGROUND OF THE INVENTION

The present invention relates to an information storage medium, an information processing device, and an information processing method.

In the related art, there are known information processing devices for generating an image viewed from a virtual camera (given viewpoint) in an object space (virtual 3D space) in which objects such as characters are arranged.

In some of this type of information processing devices, an enemy character that is present within a predetermined distance from a player's character operated by a player is locked on as an attack target, the player's character is directed in the direction of the locked-on enemy character, and the virtual camera is controlled so as to acquire an image of the player's character from behind (see JP 6318228 B).

However, in conventional information processing devices, control of a virtual camera when the player's character and a plurality of enemy characters come close to each other is not taken into consideration; thus, in an image generated when the player's character and the plurality of enemy characters come close to each other, visibility of the enemy character(s) other than the locked-on enemy character is reduced.

### SUMMARY OF THE INVENTION

The present invention has been made in view of the above-described circumstances, and an object thereof is to provide a non-transitory computer-readable information storage medium storing a program, an information processing device, and an information processing method capable of generating an image with high visibility.

According to a first aspect of the disclosure, there is provided a non-transitory computer-readable information storage medium storing a program for generating an image of a virtual space viewed from a virtual camera, the program causing a computer to function as:
an object control unit for controlling movement of a first object that can be operated by a player and one or a plurality of second objects that cannot be operated by the player, in the virtual space;
a top-priority object setting unit for setting a top-priority second object from among the second object(s) that is present around the first object;
a specific-point determining unit for determining, in the case where the other second object is present around the set top-priority second object, a specific point on the basis of the position of the top-priority second object and the position of the other second object; and
a virtual-camera control unit for controlling at least one of the position and the orientation of the virtual camera on the basis of the determined specific point.

According to a second aspect of the disclosure, there is provided an information processing device for generating an image of a virtual space viewed from a virtual camera, the information processing device comprising:
an object control unit for controlling movement of a first object that can be operated by a player and one or a plurality of second objects that cannot be operated by the player, in the virtual space;
a top-priority object setting unit for setting a top-priority second object from among the second object(s) that is present in a first range set in accordance with the position of the first object;
a specific-point determining unit for determining, in the case where the other second object is present around the set top-priority second object, a specific point on the basis of the position of the top-priority second object and the position of the other second object; and
a virtual-camera control unit for controlling at least one of the position and the orientation of the virtual camera on the basis of the determined specific point.

According to a third aspect of the disclosure, there is provided an information processing method for generating an image of a virtual space viewed from a virtual camera, the method being executed by a computer, the method comprising:
controlling movement of a first object that can be operated by a player and one or a plurality of second objects that cannot be operated by the player, in the virtual space;
setting a top-priority second object from among the second object(s) that is present in a first range set in accordance with the position of the first object;
determining, in the case where the other second object is present around the set top-priority second object, a specific point on the basis of the position of the top-priority second object and the position of the other second object; and
controlling at least one of the position and the orientation of the virtual camera on the basis of the determined specific point.

### BRIEF DESCRIPTION OF DRAWINGS

FIG. 1 is a schematic block diagram showing the configuration of an information processing system according to an embodiment of the present invention.

FIG. 2 is a functional block diagram showing the functions of a server device according to the embodiment of the present invention.

FIG. 3 is a functional block diagram showing the functions of a terminal device according to the embodiment of the present invention.

FIG. 4 is a view showing an image displayed in the terminal device according to the embodiment of the present invention.

FIG. 5 is a view showing a controller of the terminal device according to the embodiment of the present invention.

FIG. 6 is a view showing a virtual 3D space according to the embodiment of the present invention.

FIG. 7 is a view showing the virtual 3D space according to the embodiment of the present invention.

FIG. 8 is a view showing the virtual 3D space according to the embodiment of the present invention.

FIG. 9 is a view showing the virtual 3D space according to the embodiment of the present invention.

FIG. 10 is a view showing the virtual 3D space according to the embodiment of the present invention.

FIG. 11 is a view showing the virtual 3D space according to the embodiment of the present invention.

FIG. 12 is a view showing an image displayed in the terminal device according to the embodiment of the present invention.

FIG. 13 is a flowchart showing the flow of processing according to the embodiment of the present invention.

FIG. 14 is a flowchart showing the flow of the processing according to the embodiment of the present invention.

FIG. 15 is a flowchart showing the flow of the processing according to the embodiment of the present invention.

FIG. 16 is a flowchart showing the flow of the processing according to the embodiment of the present invention.

FIG. 17 is a flowchart showing the flow of the processing according to the embodiment of the present invention.

FIG. 18 is a flowchart showing the flow of the processing according to the embodiment of the present invention.

FIG. 19 is a flowchart showing the flow of the processing according to the embodiment of the present invention.

### DETAILED DESCRIPTION OF THE INVENTION

(1) The present embodiment provides a program for generating an image of a virtual space viewed from a virtual camera, the program causing a computer to function as: an object control unit for controlling movement of a first object that can be operated by a player and one or a plurality of second objects that cannot be operated by the player, in the virtual space; a top-priority object setting unit for setting a top-priority second object from among the second object(s) that is present around the first object; a specific-point determining unit for determining, in the case where the other second object is present around the set top-priority second object, a specific point on the basis of the position of the top-priority second object and the position of the other second object; and a virtual-camera control unit for controlling at least one of the position and the orientation of the virtual camera on the basis of the determined specific point.

In the present embodiment, since the specific point is determined on the basis of the position of the top-priority second object and the position of the other second object, and at least one of the position and the orientation of the virtual camera is controlled on the basis of the specific point, even if the plurality of second objects are present around the first object, the plurality of second objects can be automatically and appropriately displayed.

(2) Furthermore, according to the present embodiment, the virtual-camera control unit may control the orientation of the virtual camera such that the specific point is contained in a predetermined range in the image viewed from the virtual camera.

By doing so, the plurality of second objects can be automatically and appropriately displayed in the vicinity of the predetermined range.

(3) Furthermore, according to the present embodiment, the virtual-camera control unit may control the orientation of the virtual camera on the basis of the type of an action of the first object.

By doing so, the plurality of second objects can be automatically and appropriately displayed in accordance with the type of an action of the first object.

(4) Furthermore, according to the present embodiment, the virtual-camera control unit may control the position of the virtual camera on the basis of at least one of the position of the second object(s), the number of the second objects, and the size of the second object(s).

By doing so, the second object(s) can be automatically and appropriately displayed in accordance with at least one of the position of the second object(s), the number of the second objects, and the size of the second object(s).

(5) Furthermore, the present embodiment provides an information processing device for generating an image of a virtual space viewed from a virtual camera, the information processing device including: an object control unit for controlling movement of a first object that can be operated by a player and one or a plurality of second objects that cannot be operated by the player, in the virtual space; a top-priority object setting unit for setting a top-priority second object from among the second object(s) that is present in a first range set in accordance with the position of the first object; a specific-point determining unit for determining, in the case where the other second object is present around the set top-priority second object, a specific point on the basis of the position of the top-priority second object and the position of the other second object; and a virtual-camera control unit for controlling at least one of the position and the orientation of the virtual camera on the basis of the determined specific point.

(6) Furthermore, the present embodiment provides an information processing method for generating an image of a virtual space viewed from a virtual camera, the method being executed by a computer, the method including: controlling movement of a first object that can be operated by a player and one or a plurality of second objects that cannot be operated by the player, in the virtual space; setting a top-priority second object from among the second object(s) that is present in a first range set in accordance with the position of the first object; determining, in the case where the other second object is present around the set top-priority second object, a specific point on the basis of the position of the top-priority second object and the position of the other second object; and controlling at least one of the position and the orientation of the virtual camera on the basis of the determined specific point.

(7) Furthermore, the present embodiment provides a non-transitory computer readable information storage medium storing a program for generating an image of a virtual space viewed from a virtual camera, the program causing a computer to function as: an object control unit for controlling movement of a first object that can be operated by a player and one or a plurality of second objects that cannot be operated by the player, in the virtual space; a top-priority object setting unit for setting a top-priority second object from among the second object(s) that is present around the first object; a specific-point determining unit for determining, in the case where the other second object is present around the set top-priority second object, a specific point on the basis of the position of the top-priority second object and the position of the other second object; and a virtual-camera control unit for controlling at least one of the position and the orientation of the virtual camera on the basis of the determined specific point.

An embodiment of the present invention will be described below. Note that this embodiment to be described below does not unduly limit the content of the present invention described in claims. Furthermore, all the configurations described in this embodiment are not necessarily be indispensable constituent features of the present invention.

### 1. Configuration of Information Processing System

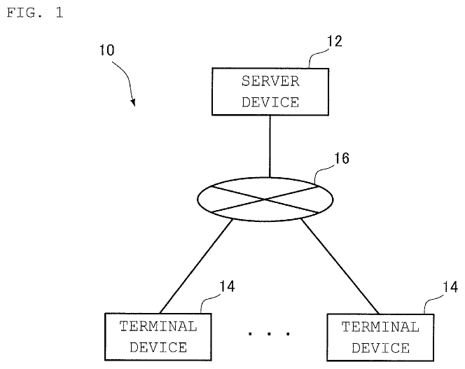

FIG. 1 is a schematic block diagram showing the configuration of an information processing system 10 of this embodiment. As shown in FIG. 1, in the information processing system 10, a server device 12 and a plurality of terminal devices 14 are connected via a network 16, such as the Internet, a mobile-phone network, a LAN, or a WAN, whereby a so-called client-server communication system is configured. Then, each of the plurality of terminal devices 14 communicates with the server device 12 via the network 16 to send and receive various kinds of information thereto and therefrom, and communicates with the other terminal device(s) 14 via the network 16 and the server device 12 to send and receive various kinds of information thereto and therefrom.

The server device 12 includes a processor such as a CPU, a main storage device such as a ROM and a RAM, an external storage device such as a hard disk, an input device such as a keyboard, a display device such as a liquid crystal display, a communication device, etc. Then, at the server device 12, the CPU executes various kinds of processing according to a program stored in the main storage device and a program loaded from the external storage device into the main storage device, and receives information from the terminal devices 14 and sends information to the terminal devices 14 by means of the communication device.

The terminal devices 14 can be various types of information processing devices, such as smartphones, tablet devices, personal computers, portable game machines, or installed game machines. These terminal devices 14 also include: a processor such as a CPU; a main storage device such as a ROM and a RAM; flash memory; an external storage device such as a hard disk; an input device such as a touchscreen, a keyboard, and a microphone; a display device such as a liquid crystal display or an organic EL display; a sound output device such as a speaker; a communication device; etc. Then, also at each of the terminal devices 14, the CPU executes various kinds of processing according to a program stored in the main storage device and a program loaded from the external storage device into the main storage device, and receives information from the server device 12 and sends information to the server device 12 and the other terminal device(s) 14 by means of the communication device.

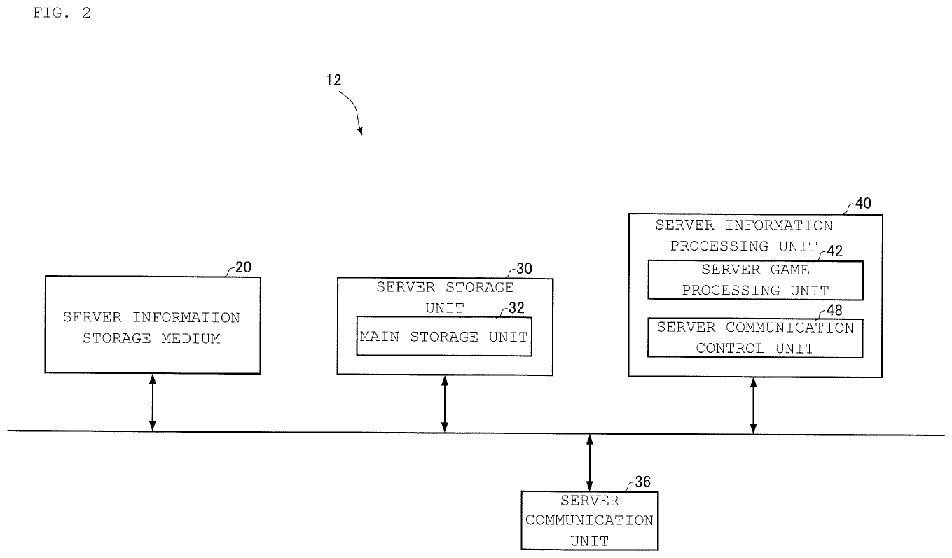

FIG. 2 is a functional block diagram showing the functions of the server device 12 of this embodiment. As shown in FIG. 2, the server device 12 of this embodiment includes a server information storage medium 20, a server storage unit 30, a server communication unit 36, and a server information processing unit 40. Note that it is also possible to adopt a configuration in which part of the constituents (individual units) shown in FIG. 2 is omitted.

The server information storage medium 20 stores a program and data used when the server information processing unit 40 and the server communication unit 36 perform various kinds of processing, and the function of the server information storage medium 20 can be realized by flash memory, a hard disk, an optical disk (DVD, BD), or the like. Specifically, a program causing a computer to function as the individual units of this embodiment (a program causing a computer to execute processing of the individual units) is stored in the server information storage medium 20.

The server storage unit 30 serves as a work area for the server information processing unit 40 and the server communication unit 36, and the function thereof can be realized by a RAM (main memory), a VRAM (video memory), or the like. In detail, the server storage unit 30 includes a main storage unit 32 into which programs and data are loaded from the server information storage medium 20.

The server communication unit 36 performs various kinds of control for performing communication with an external network (for example, with another server device 12 and the terminal devices 14), and the function thereof can be realized by hardware, such as various processors (CPU (main processor), GPU (drawing processor), DSP, etc.) or a communication ASIC, and a program.

The server information processing unit 40 performs various kinds of processing such as game processing by using the main storage unit 32 as a work area, on the basis of received data received by the server communication unit 36 and various programs and data stored in the server storage unit 30. The function of the server information processing unit 40 can be realized by hardware, such as various processors or an ASIC, and a program.

Then, the server information processing unit 40 includes a server game processing unit 42 and a server communication control unit 48. Note that it is also possible to adopt a configuration in which part of these constituents is omitted.

The server game processing unit 42 performs processing for starting a game when a game start condition is satisfied, processing for executing a game function selected from among a plurality of types of game functions, processing for matching a plurality of players (player identification information, player IDs) to form one group, processing for making a plurality of players forming one group participate in a common game, processing for controlling a battle game, processing for proceeding with a game, processing for determining game media, such as a character and an item, to be provided (assigned) to the player, from among a plurality of game media by lottery, processing for making an event occur when an event occurrence condition is satisfied, processing for calculating a game result, or processing for ending a game when a game end condition is satisfied, on the basis of received data received by the server communication unit 36, results of various kinds of processing performed in the server information processing unit 40, and programs and data loaded into the main storage unit 32.

The server communication control unit 48 makes the server communication unit 36 perform communication with another server device 12 or the terminal devices 14, to perform processing for sending and receiving various kinds of information thereto and therefrom. For example, the server communication control unit 48 makes the server communication unit 36 send and receive information required for processing for registering a player to the information processing system 10, information required for processing for letting the player log in to the information processing system 10, information required for processing for setting an opponent player who plays with or against the player who has been allowed to log in, information required for processing for synchronizing a plurality of terminal devices 14, and information required for processing for executing a common game at the plurality of terminal devices 14. Furthermore, the server communication control unit 48 makes the server communication unit 36 also send and receive destination information indicating the destination of information, sender information indicating the sender of information, and identification information for identifying the information processing system 10 that has generated information.

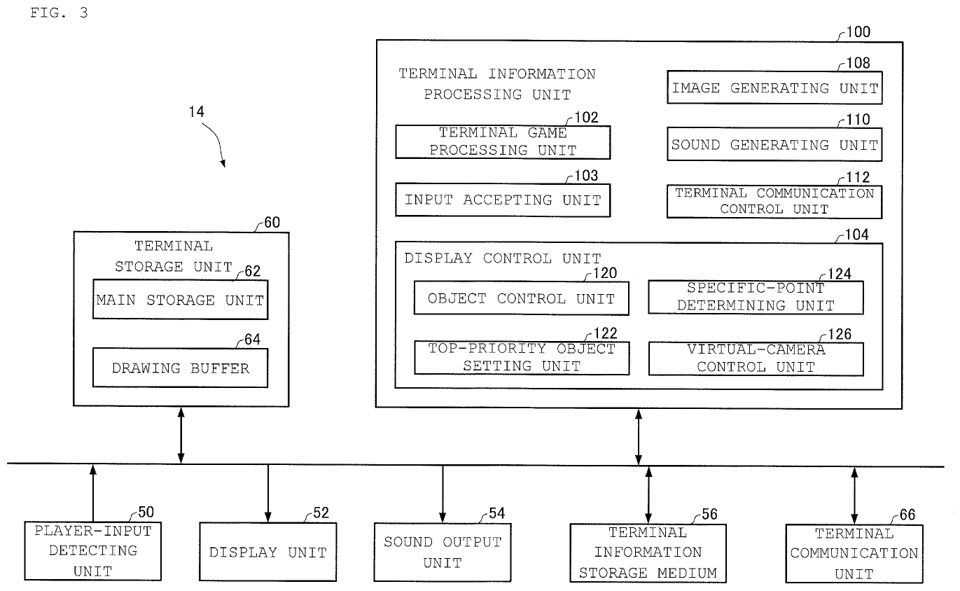

FIG. 3 is a functional block diagram showing the functions of each of the terminal devices 14 of this embodiment. As shown in FIG. 3, the terminal device 14 of this embodiment includes a player-input detecting unit 50, a display unit 52, a sound output unit 54, a terminal information storage medium 56, a terminal storage unit 60, a terminal communication unit 66, and a terminal information processing unit 100. Note that it is also possible to adopt a configuration in which part of the constituents (individual units) shown in FIG. 3 is omitted.

The player-input detecting unit 50 detects an input from the player with respect to the terminal device 14 as a player input, and the function thereof can be realized by a touch sensor, a switch, an optical sensor, a variable resistance sensor (potentiometer), an acceleration sensor, a microphone, or the like.

The display unit 52 displays images on a display screen, and the function thereof can be realized by a liquid crystal display, an organic EL display, or the like.

The sound output unit 54 outputs sound, and the function thereof can be realized by a speaker, a headphone, or the like.

The terminal information storage medium 56 stores programs and data used when the terminal information processing unit 100 and the terminal communication unit 66 perform various kinds of processing. The function of the terminal information storage medium 56 can be realized by flash memory, a hard disk, an optical disk (DVD, BD), or the like. Specifically, the terminal information storage medium 56 stores a program causing a computer to function as the individual units (a program causing a computer to execute processing of the individual units) of this embodiment.

The terminal storage unit 60 serves as a work area for the terminal information processing unit 100 and the terminal communication unit 66, and the function thereof can be realized by a RAM (main memory), a VRAM (video memory), or the like. Specifically, the terminal storage unit 60 includes a main storage unit 62 into which programs and data are loaded from the terminal information storage medium 56 and a drawing buffer 64 in which an image to be displayed on the display unit 52 is drawn.

The terminal communication unit 66 performs various kinds of control for performing communication with an external network (for example, with the server device 12 and the other terminal device(s) 14), and the function thereof can be realized by hardware, such as various processors or a communication ASIC, and a program.

Note that the program (data) causing a computer to function as the individual units of this embodiment may also be downloaded from the server device 12 to the terminal information storage medium 56 (or the main storage unit 62) of the terminal device 14 via the network 16 and the terminal communication unit 66, and such use of the server device 12 can be encompassed within the scope of the present invention.

The terminal information processing unit 100 performs various kinds of processing, such as game processing, image generation processing, and sound generation processing, by using the main storage unit 62 as a work area, on the basis of a player input detected by the player-input detecting unit 50, received data received by the terminal communication unit 66, and various types of programs and data in the terminal storage unit 60. The function of the terminal information processing unit 100 can be realized by hardware, such as various processors (CPU (main processor), GPU (drawing processor), DSP, etc.) and an ASIC, and a program.

Then, the terminal information processing unit 100 includes a terminal game processing unit 102, an input accepting unit 103, a display control unit 104, an image generating unit 108, a sound generating unit 110, and a terminal communication control unit 112. Note that it is also possible to adopt a configuration in which part of these constituents is omitted.

The terminal game processing unit 102 (game processing unit) performs processing for starting a game when a game start condition is satisfied, processing for executing a game function selected from among a plurality of types of game functions, processing for matching the player (player ID) of the local terminal with a player (another player ID) of another terminal to make the players participate in a common game, processing for controlling a battle game, processing for proceeding with a game, processing for making an event occur when an event occurrence condition is satisfied, processing for updating various parameters of the player of the local terminal or characters, processing for calculating a game result, or processing for ending a game when a game end condition is satisfied, on the basis of a player input detected by the player-input detecting unit 50, received data received by the terminal communication unit 66, results of various kinds of processing performed in the terminal information processing unit 100, and programs and data loaded into the main storage unit 62.

The input accepting unit 103 accepts an input from the player as an input corresponding to the situation or does not accept an input from the player, on the basis of a player input detected by the player-input detecting unit 50, received data received by the terminal communication unit 66, results of various kinds of processing performed in the terminal information processing unit 100, and programs and data loaded into the main storage unit 62. For example, when a GUI such as a button is tapped while the GUI being displayed, the input accepting unit 103 accepts this operation as an input corresponding to the type of the displayed GUI.

The display control unit 104 performs display control on an image to be displayed on the display unit 52. Specifically, the display control unit 104 performs display control on the display content, the display mode, and the display timing of various objects and a pre-rendered image (movie image), on the basis of a player input detected by the player-input detecting unit 50, received data received by the terminal communication unit 66, results of various kinds of processing performed in the terminal information processing unit 100, and programs and data loaded into the main storage unit 62.

For example, the terminal information storage medium 56 stores: object data on various objects, such as background objects for displaying backgrounds, effect objects for displaying effects, GUI objects for displaying GUIs (Graphical User Interfaces) such as buttons, character objects for displaying a player's character (first object) whose movement and action are operable by the player and one or a plurality of enemy characters (second objects) whose movement and action are inoperable by the player, and non-character objects for displaying objects other than characters, e.g., buildings, tools, vehicles, and landforms; and image data on various pre-rendered images.

Then, the display control unit 104 performs display control on objects and pre-rendered images, on the basis of the object data and the image data on pre-rendered images, the data being loaded into the main storage unit 62, in accordance with the type of a game function being executed and the situation of the progression of the game.

Here, when displaying a 3D game image, the display control unit 104 performs processing for arranging objects each composed of primitives, such as a polygon, a freeform surface, and a 2D image, which express the object, in a virtual 3D space (virtual space) and for making the objects move or act, on the basis of the object data loaded into the main storage unit 62. Furthermore, the display control unit 104 performs processing for controlling the position, the orientation (viewing direction), and the angle of view (the field of view) of a virtual camera (viewpoint) for generating an image viewed from a given (arbitrary) viewpoint in the virtual 3D space.

More specifically, the display control unit 104 includes an object control unit 120, a top-priority object setting unit 122, a specific-point determining unit 124, and a virtual-camera control unit 126.

The object control unit 120 performs processing for arranging, in a virtual 3D space, various objects composed of primitive surfaces of polygons etc. Specifically, the object control unit 120 determines, for every single frame ( 1/30 seconds), the position and the orientation (rotation angle) of an object in the world coordinate system on the basis of a player input detected by the player-input detecting unit 50, received data received by the terminal communication unit 66, results of various kinds of processing performed in the terminal information processing unit 100, programs and data loaded into the main storage unit 62, etc., and arranges the object at the determined position (3D coordinates) in the determined orientation.

Furthermore, the object control unit 120 performs movement calculation or motion calculation (movement or motion simulation) on objects that move or act, such as the player's character and the enemy characters. Specifically, the object control unit 120 calculates, for every single frame, movement information (the position, the rotation angle, the speed, the acceleration, etc.) of each object and motion information (the position, the rotation angle, the speed, the acceleration, etc. of each part that constitutes the object) of the object, on the basis of a player input detected by the player-input detecting unit 50, received data received by the terminal communication unit 66, results of various kinds of processing performed in the terminal information processing unit 100, a movement algorithm, a motion algorithm, and motion data loaded into the main storage unit 62, and performs processing for making the object move in the virtual 3D space and for making a plurality of parts that constitute the object act (for animating the plurality of parts).

In particular, in the case where the object is a character object, the object control unit 120 controls the motion of the character object on the basis of motion data associated with each character. Specifically, the motion data includes the positions and rotation angles (rotation angles of child's bones with respect to parent's bones) of individual bones (parts objects, joints, and motion bones that constitute a character) that constitute the skeleton of a character object. The object control unit 120 moves the individual bones that constitute the skeleton of the character object or deforms the skeleton shape on the basis of the motion data, thus controlling an offense motion, a defense motion, a movement motion, etc., of the character object.

The top-priority object setting unit 122 detects enemy characters that are present in a range based on the position of the player's character and sets a top-priority enemy character from among the detected enemy characters.

The specific-point determining unit 124 determines a specific point on the basis of the position of the top-priority enemy character in the case where the other enemy character is not present around the set top-priority enemy character, and determines a specific point on the basis of the position of the top-priority enemy character and the position of the other enemy character in the case where the other enemy character is present around the set top-priority enemy character.

The virtual-camera control unit 126 performs processing for controlling the virtual camera (viewpoint) for generating an image viewed from a given (arbitrary) viewpoint in the virtual 3D space. Specifically, the virtual-camera control unit 126 determines, for every single frame ( 1/30 seconds), the position, the orientation (rotation angle), and the angle of view of the virtual camera in the world coordinate system on the basis of a player input detected by the player-input detecting unit 50, received data received by the terminal communication unit 66, results of various kinds of processing performed in the terminal information processing unit 100, programs and virtual-camera control data loaded into the main storage unit 62, etc., and arranges the virtual camera at the determined position, in the determined orientation, and at the determined angle of view.

Here, it is also possible that a fixation point that is a point viewed by the virtual camera is set in the virtual 3D space, and the orientation of the virtual camera is controlled so as to be directed to the set fixation point. Furthermore, the angle of view of the virtual camera may be controlled by enlarging and narrowing the angle of view or may be controlled by changing the distance between the virtual camera and a screen (projection plane) on which an object is projected. Note that it is possible to generate an image in which a target object is zoomed up by narrowing the angle of view of the virtual camera or by increasing the distance between the screen and the virtual camera, and it is possible to generate an image in which a target object is zoomed back by enlarging the angle of view of the virtual camera or by reducing the distance between the screen and the virtual camera.

Furthermore, the virtual-camera control unit 126 controls the position, the orientation, and the angle of view of the virtual camera such that the virtual camera follows changes in the position and the orientation of the player's character, which performs movement and actions on the basis of player inputs, and such that the position, the orientation, and the angle of view of the virtual camera change on the basis of player inputs.

Furthermore, the virtual-camera control unit 126 controls the position, the orientation, and the angle of view of the virtual camera such that the position of the virtual camera moves to a predetermined position or moves in a predetermined movement route, the orientation of the virtual camera rotates at a predetermined rotation angle, and the angle of view of the virtual camera changes at a predetermined angle of view, on the basis of the virtual-camera control data for identifying the position (movement route), the orientation, the angle of view, and the fixation point of the virtual camera. The virtual-camera control data may include: the position, the rotation angle, the angle of view, and the position of the fixation point of the virtual camera, for each single frame; and the amount of change, the rate of change, the change period (the number of frames), etc., of the position, the rotation angle, the angle of view, and the fixation point of the virtual camera, for each single frame.

Furthermore, the virtual-camera control unit 126 controls at least one of the position and the orientation of the virtual camera on the basis of the specific point determined by the specific-point determining unit 124.

The image generating unit 108 performs, for each single frame, processing for drawing a game image in the drawing buffer 64, to generate a game image in which various objects or various pre-rendered images are displayed, on the basis of a player input detected by the player-input detecting unit 50, received data received by the terminal communication unit 66, results of various kinds of processing performed in the terminal information processing unit 100, results of various kinds of processing performed particularly in the display control unit 104, programs and data loaded into the main storage unit 62, etc., and outputs the generated game image to the display unit 52 to make the game image displayed thereon.

In the case where a 3D game image is generated, object data (model data) including vertex data (vertex position coordinates, texture coordinates, color data, normal vectors, or an alpha value) about each vertex of an object (model) is obtained on the basis of the results of various kinds of processing performed in the display control unit 104, and vertex processing (shading using a vertex shader) is performed on the basis of the vertex data included in the obtained object data.

In the vertex processing, geometry processing, such as vertex movement processing, coordinate transformation (world coordinate transformation, camera coordinate transformation), a clipping process, or perspective transformation, is performed according to a vertex processing program (a vertex shader program), and the vertex data given to each of the vertices constituting the object is changed (updated, adjusted) on the basis of the processing result.

After the vertex processing is performed, rasterization (scan conversion) is performed on the basis of the vertex data obtained after the vertex processing, and a polygon (primitive) surface and pixels are made to correspond. After the rasterization is performed, pixel processing (shading using a pixel shader, fragment processing) for drawing pixels constituting an image (fragments constituting a display screen) is performed.

In the pixel processing, various kinds of processing, such as texture mapping, hidden-surface removal, setting/changing of color data, translucent composition, and anti-aliasing, are performed according to a pixel processing program (pixel shader program), to determine final drawing colors of pixels constituting the image, and the drawing colors of the object on which the perspective transformation has been performed are output (drawn) to the drawing buffer 64 (buffer that can store drawing information on a pixel basis, rendering target). Specifically, in the pixel processing, per-pixel processing for setting or changing image information (color value, brightness value, Z value, normal line, alpha value, etc.) on a pixel basis is performed. Accordingly, an image viewed from the virtual camera (given viewpoint) in the virtual 3D space is generated.

The sound generating unit 110 performs sound processing on the basis of the results of various kinds of processing performed in the terminal information processing unit 100, to generate game sound, such as a song, BGM, sound effect, or speech sound, and outputs the game sound to the sound output unit 54.

The terminal communication control unit 112 makes the terminal communication unit 66 communicate with the server device 12 or the other terminal device(s) 14 to perform processing for sending and receiving various kinds of information. For example, the terminal communication control unit 112 makes the terminal communication unit 66 send and receive information required for processing for registering the player to the information processing system 10, information required for processing for letting the player log in to the information processing system 10, information required for processing for setting an opponent player who plays with or against the player who has been allowed to log in, information required for processing for synchronizing a plurality of terminal devices 14, and information required for processing for executing a common game at the plurality of terminal devices 14. Furthermore, the terminal communication control unit 112 also makes the terminal communication unit 66 send and receive destination information indicating the destination of information, sender information indicating the sender of information, and identification information for identifying the information processing system 10 that has generated information.

Note that a portion or the entirety of the function of the terminal information storage medium 56 of the terminal device 14, a portion or the entirety of the function of the terminal storage unit 60 thereof, a portion or the entirety of the function of the terminal communication unit 66 thereof, and a portion or the entirety of the function of the terminal information processing unit 100 thereof may be provided at the server device 12, and a portion or the entirety of the function of the server information storage medium 20 of the server device 12, a portion or the entirety of the function of the server storage unit 30 thereof, a portion or the entirety of the function of the server communication unit 36 thereof, and a portion or the entirety of the function of the server information processing unit 40 thereof may be provided at the terminal device 14.

### 2. Control Method of This Embodiment

A control method of this embodiment will be described in detail below by using an example case in which the terminal device 14 is applied as a console video game machine, and a game program of this embodiment is applied as a game application for the console video game machine.

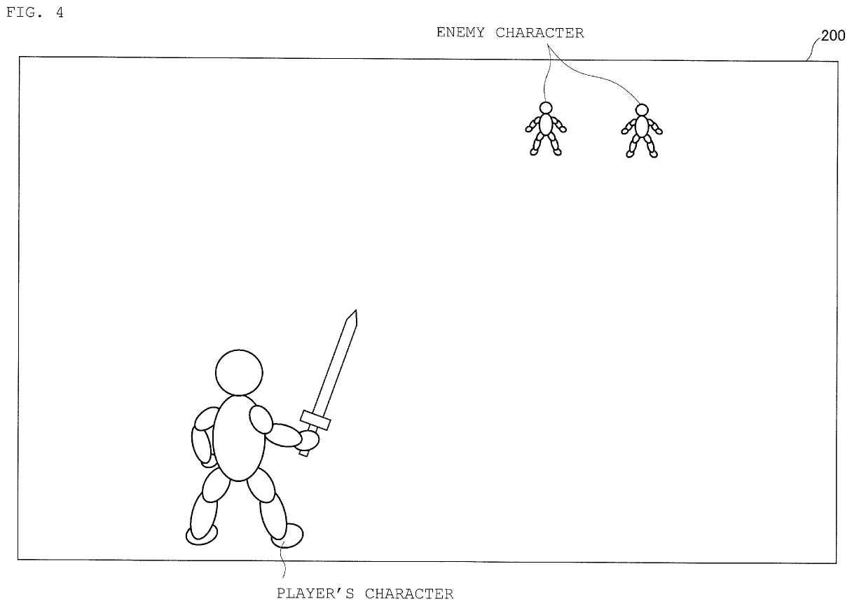

FIG. 4 is a view showing an example of a game image generated by the game program of this embodiment and displayed on a display 200. The game program of this embodiment is configured so as to be able to execute an action game viewed from a third person point of view, generates an image in which the player's character is viewed from the right rear of the player's character, as shown in FIG. 4, and makes the image displayed on the display 200. In the example shown in FIG. 4, two enemy characters are displayed in front of the player's character.

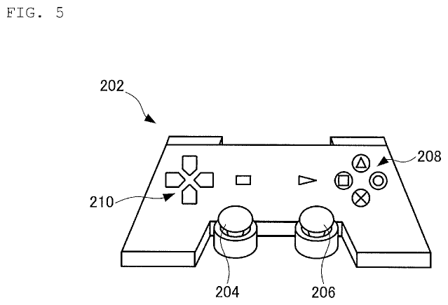

While viewing the display 200, the player performs inputs for making the player's character move and act, by using a controller 202 of the console video game machine shown in FIG. 5, and enjoys a game for performing a battle with a plurality of enemy characters that move and act according to a given algorithm.

As shown in FIG. 5, a left analog stick 204, a right analog stick 206, a plurality of buttons 208, a directional pad 210, etc., are provided in the controller 202, and the direction in which and the amount by which each of the left analog stick 204 and the right analog stick 206 is tilted are detected by a variable resistance sensor.

Then, when an operation for tilting the left analog stick 204 is performed, the operation is detected as a movement input for moving the player's character, and the player's character moves in accordance with the direction in which and the amount by which the left analog stick 204 is tilted. When an operation for tilting the right analog stick 206 is performed, the operation is detected as a virtual-camera input for changing the orientation of the virtual camera, and the orientation of the virtual camera changes in accordance with the direction in which and the amount by which the right analog stick 206 is tilted.

Furthermore, when an operation for pressing any of the buttons 208 or the directional pad 210 is performed, the operation is detected as an attack input for making the player's character perform an attack action on any of the enemy characters or as an avoidance input for making the player's character perform an avoidance action with respect to an attack from any of the enemy characters, depending on the kind of the pressed button 208 or the pressed position of the directional pad 210.

The virtual camera is basically disposed at a reference position away from the position of the player's character toward the right rear by a predetermined distance and is directed so as to be slightly tilted toward the left with respect to the orientation of the player's character, and, as shown in FIG. 4, the player's character is displayed at a position shifted from the center of the display area of the display 200 toward the lower left. Then, when the player's character moves, thus changing the position and the orientation of the player's character, the position and the orientation of the virtual camera are controlled so as to follow the changes of the position and the orientation of the player's character.

Specifically, in a state in which a virtual-camera input, an attack input, or an avoidance input is not performed, when a movement input is performed, thus changing the position and the orientation of the character, the position and the orientation of the virtual camera are controlled such that the relationship between the position of the player's character and the position of the virtual camera and the relationship between the orientation of the player's character and the orientation of the virtual camera become predetermined relationships.

However, in the case where close fighting is performed with enemy characters, if the orientation of the virtual camera changes so as to follow the orientation of the player's character, a problem arises in which the enemy characters are not displayed in some cases, whereby it becomes difficult to fight against the enemy characters.

Thus, in the game program of this embodiment, every time the frame is updated, and the arrangement of objects is thus updated, one enemy character is set as a top-priority target (top-priority object) on the basis of an input from the player, the position relationship between the player's character and the enemy characters, etc., and correction processing is performed for correcting (controlling) at least one of the position and the orientation of the virtual camera such that the top-priority target is automatically displayed.

Specifically, in the case where a movement input, an attack input, or an avoidance input is performed, a virtual-camera input is not performed, and the player's character is equipped with a melee weapon, enemy-character detection processing for detecting enemy characters serving as targets of the correction processing is first performed.

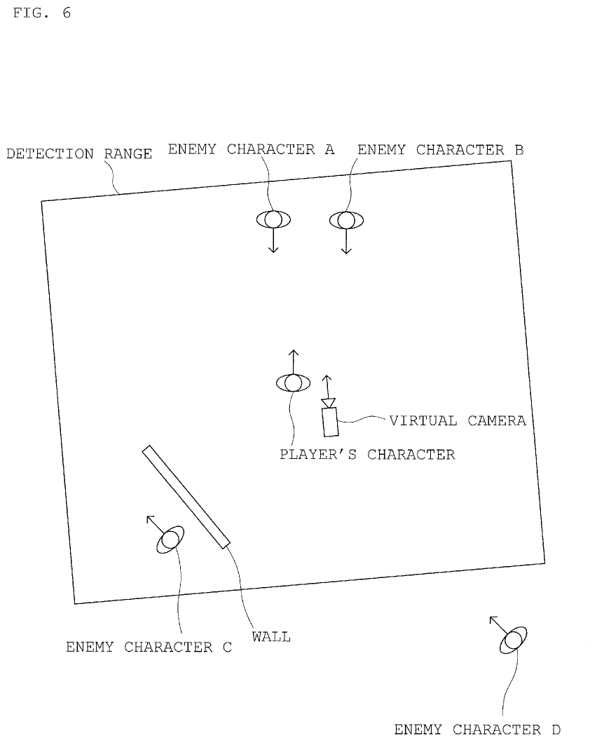

FIG. 6 is a view of the virtual 3D space viewed from the top when the example image shown in FIG. 4 is generated. In the enemy-character detection processing, as shown in FIG. 6, enemy characters that are present (around the first object) in a detection range that is rectangular parallelepiped whose bottom surface is square are detected, and the detected enemy characters are set as processing-target enemy characters.

The detection range is set so as to follow the position of the player's character and the orientation of the virtual camera, such that the player's character is positioned at the center of the bottom surface of the detection range and such that the detection range is directed to the same direction as the orientation of the virtual camera.

Note that an enemy character that is in a blocked state of being blocked by an object such as a wall, when viewed from the player's character, is excluded from the processing-target enemy characters even if the enemy character is present in the detection range.

In the example shown in FIG. 6, although an enemy character A, an enemy character B, and an enemy character C are detected as enemy characters in the detection range, since the enemy character C is in the blocked state, the enemy character C is excluded, and the enemy character A and the enemy character B are set as the processing-target enemy characters.

Note that, if an enemy character that was set as the top-priority target in the previous frame is present in the detection range, even when the enemy character is in the blocked state, the setting of the top-priority target is maintained until two seconds have elapsed while the enemy character is in the blocked state, and the enemy character is not excluded from the processing-target enemy characters.

Thus, after two seconds have elapsed while the enemy character that was set as the top-priority target in the previous frame is in the blocked state, the setting of the top-priority target is released, and the enemy character is excluded from the processing-target enemy characters.

Accordingly, even when the enemy character that is set as the top-priority target is in the blocked state only for a moment due to movement of the player's character or the enemy character that is set as the top-priority target or a change in the orientation of the virtual camera, the setting of the top-priority target is maintained, whereby it is possible to prevent the top-priority target from being frequently changed.

Note that the size of the detection range is different depending on the types of enemy characters arranged in the virtual 3D space, and the size of the detection range to be set is increased as the size of an enemy character becomes larger.

As a result of the enemy-character detection processing, in the case where the processing-target enemy characters are present, top-priority-target setting processing is performed for setting, as the top-priority target, one enemy character of the processing-target enemy characters. A condition for the top-priority target is different depending on the game situation; the enemy character that is an attack target is set as the top-priority target in the case where the player's character is performing an attack action using a melee weapon, and the enemy character that is attacking the player's character is set as the top-priority target in the case where the player's character is performing an avoidance action.

Furthermore, in the case where the player's character is not performing an attack action or an avoidance action, e.g., in the case where the player's character is moving, the top-priority target enemy character is set on the basis of an input from the player, the position relationship between the player' s character and the enemy character, etc.

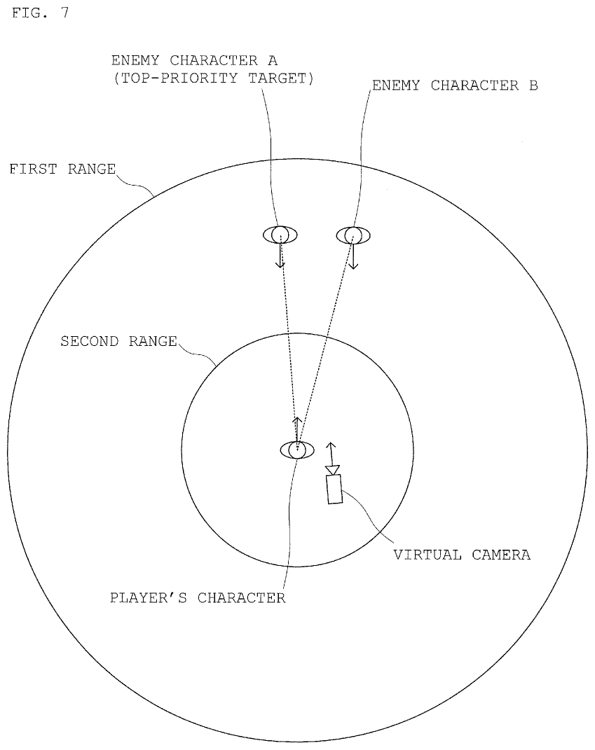

FIG. 7 is a view showing the position relationship between the player's character and the enemy characters. As shown in FIG. 7, in the case where the processing-target enemy characters are present in a first range centered on the position of the player's character, the enemy character that is the closest to the player's character is basically set as the top-priority target. Note that the first range is contained in the detection range shown in FIG. 6, and a second range centered on the position of the player's character is contained in the first range.

In the example shown in FIG. 7, since the enemy character A is a processing-target enemy character that is the closest to the player's character, the enemy character A is set as the top-priority target.

Note that, even when the enemy character that was set as the top-priority target in the previous frame is not the closest to the player's character, if this enemy character is present in the first range and if the other processing-target enemy character that is closer to the player's character than this enemy character is not present in the second range, the setting of the top-priority target is maintained.

Thus, in the case where the enemy character that was set as the top-priority target in the previous frame is not present in the first range, and the other processing-target enemy character is present in the first range, the processing-target enemy character that is the closest to the player's character in the first range is set as the top-priority target, instead of the enemy character that was set as the top-priority target in the previous frame.

Furthermore, in the case where, even when the enemy character that was set as the top-priority target in the previous frame is present in the first range, if the other processing-target enemy character that is closer to the player's character than this enemy character is present in the second range, the setting of the top-priority target is released, and the other processing-target enemy character that is the closest to the player's character in the second range is set as the top-priority target.

Accordingly, even when the enemy character that is the closest to the player's character is replaced inside the first range but outside the second range due to movement of the player's character or the enemy character(s), the setting of the top-priority target is maintained, whereby it is possible to prevent the top-priority target from being frequently changed.

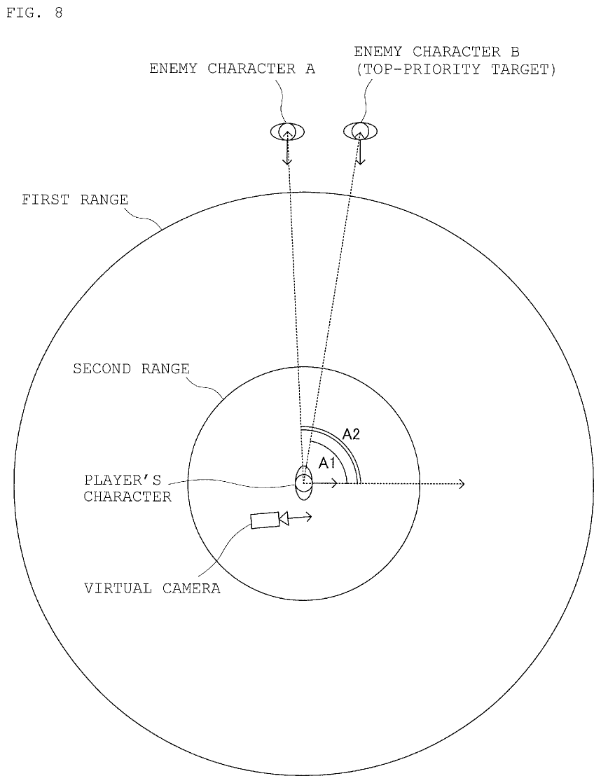

On the other hand, as shown in FIG. 8, in the case where the processing-target enemy characters are not present in the first range, i.e., in the case where processing-target enemy characters are present outside the first range, and in the case where a movement input is performed, the enemy character of which the angular difference between the movement direction of the player's character and the direction toward this enemy character from the player's character is the smallest is set as the top-priority target.

In the example shown in FIG. 8, although the enemy character A is a processing-target enemy character that is the closest to the player's character, the enemy character B is set as the top-priority target because the movement direction of the player's character is in the right direction in the figure, the angular difference A1 between the movement direction of the player's character and the direction toward the enemy character B is smaller than the angular difference A2 between the movement direction of the player's character and the direction toward the enemy character A, and the enemy character B is a processing-target enemy character of which the angular difference with respect to the movement direction of the player's character is the smallest.

Note that, even when the enemy character that was set as the top-priority target in the previous frame does not have the smallest angular difference with respect to the movement direction of the player's character, if the other processing-target enemy character is not present of which the angular difference with respect to the movement direction of the player's character is equal to or smaller than a first angle, the setting of the top-priority target in the previous frame is maintained.

Thus, in the case where the other processing-target enemy character is present of which the angular difference with respect to the movement direction of the player's character is equal to or smaller than the first angle and is smaller than that of the top-priority target, the other processing-target enemy character of which the angular difference with respect to the movement direction of the player's character is the smallest is set as the top-priority target, instead of the enemy character that was set as the top-priority target in the previous frame.

Accordingly, even when the enemy character of which the angular difference with respect to the movement direction of the player's character is the smallest is replaced, while the angular difference thereof is larger than the first angle, due to movement of the player's character or the enemy character(s), the setting of the top-priority target is maintained, whereby it is possible to prevent the top-priority target from being frequently changed.

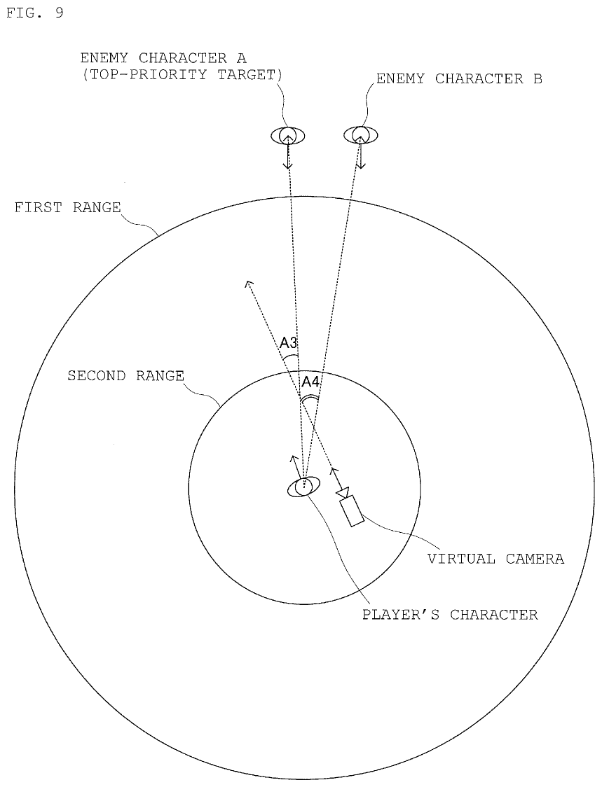

Furthermore, as shown in FIG. 9, in the case where the processing-target enemy characters are not present in the first range, i.e., in the case where the processing-target enemy characters are present outside the first range, and in the case where a movement input is not performed, the enemy character of which the angular difference between the orientation of the virtual camera and the direction toward this enemy character from the player's character is the smallest is set as the top-priority target.

In the example shown in FIG. 9, the enemy character A is set as the top-priority target because the orientation of the virtual camera is in the upper left direction in the figure, the angular difference A3 between the orientation of the virtual camera and the direction toward the enemy character A is smaller than the angular difference A4 between the orientation of the virtual camera and the direction toward the enemy character B, and the enemy character A is a processing-target enemy character of which the angular difference with respect to the orientation of the virtual camera is the smallest.

Note that, even when the enemy character that was set as the top-priority target in the previous frame does not have the smallest angular difference with respect to the orientation of the virtual camera, if no other processing-target enemy character is present of which the angular difference with respect to the orientation of the virtual camera is equal to or smaller than a second angle, the setting of the top-priority target in the previous frame is maintained.

Thus, in the case where the other processing-target enemy character is present of which the angular difference with respect to the orientation of the virtual camera is equal to or smaller than the second angle and is smaller than that of the top-priority target, the other processing-target enemy character of which the angular difference with respect to the orientation of the virtual camera is the smallest is set as the top-priority target, instead of the enemy character that was set as the top-priority target in the previous frame.

Accordingly, even when the enemy character of which the angular difference with respect to the orientation of the virtual camera is the smallest is replaced, while the angular difference thereof is larger than the second angle, due to movement of the player's character or the enemy character(s), the setting of the top-priority target is maintained, whereby it is possible to prevent the top-priority target from being frequently changed.

After the top-priority target is set, specific-point determination processing for determining a specific point for controlling the orientation of the virtual camera is performed on the basis of the position of the top-priority-target enemy character.

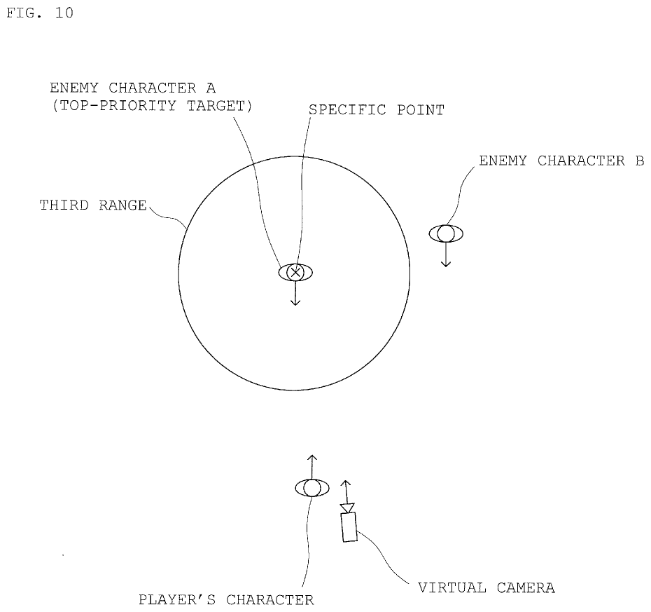

FIG. 10 is a view showing the position relationship between the top-priority target and the specific point. As shown in FIG. 10, in the case where the other processing-target enemy character is not present in a third range centered on the position of the top-priority-target enemy character (around the top-priority second object), the position of the top-priority-target enemy character is set as the specific point.

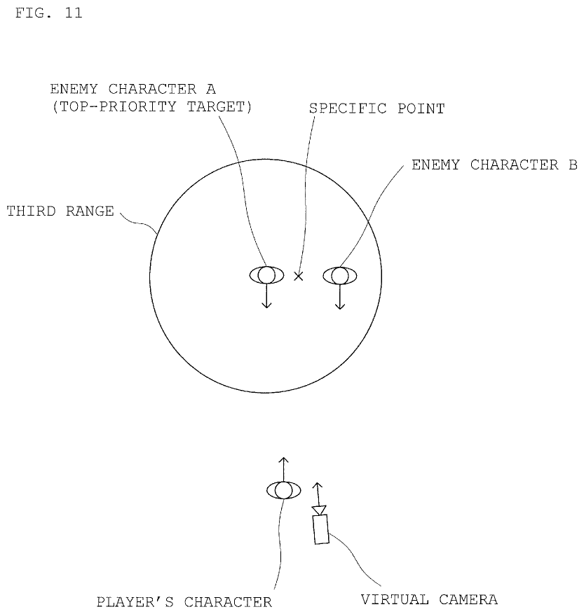

On the other hand, as shown in FIG. 11, in the case where the other processing-target enemy character is present in the third range, the specific point is determined on the basis of the position of the top-priority-target enemy character and the position of the other processing-target enemy character.

Specifically, the specific point is determined by calculating the gravity center of the positions of the enemy characters in the third range while weighting the positions of the enemy characters in the third range such that the weight of the position of the top-priority-target enemy character is the heaviest.

In the example shown in FIG. 11, since the enemy character B is present on the right side of the top-priority-target enemy character A in the third range, the specific point is determined at the position shifted toward the right from the position of the top-priority-target enemy character A on the basis of the position of the enemy character A, the position of the enemy character B, and the weights of the positions of the individual enemy characters.

Accordingly, the orientation of the virtual camera can be controlled such that, even in the case where a plurality of enemy characters are present, the player can easily recognize the positions of the individual enemy characters.

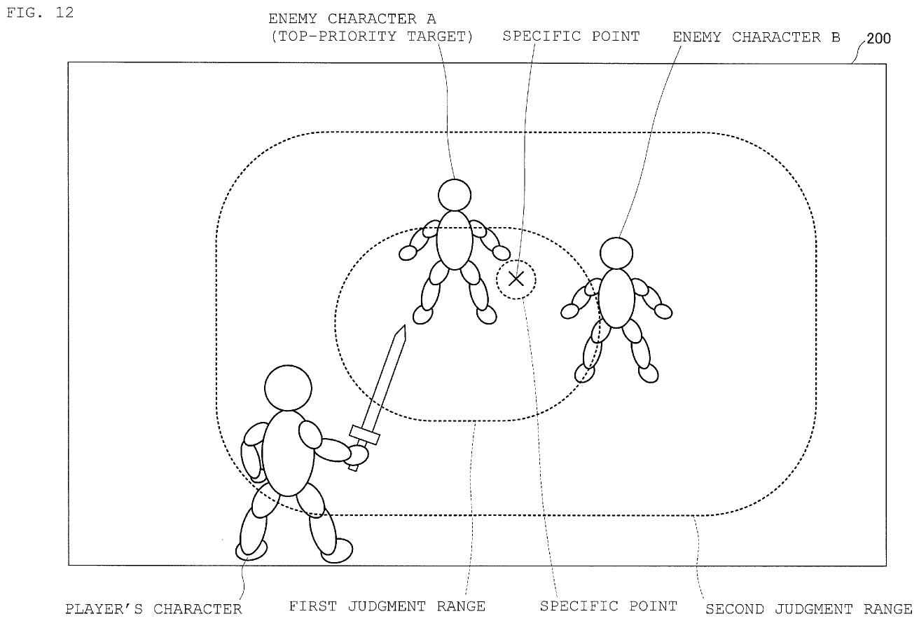

FIG. 12 is a view showing an example of a game image displayed on the display 200. In the example shown in FIG. 12, although the enemy character A is set as the top-priority target, since the enemy character B is present on the right side of the top-priority-target enemy character A in the above-described third range, the specific point is determined at the position shifted toward the right from the position of the top-priority-target enemy character A.

After the specific point is determined, in the case where the player's character is performing an attack action using a melee weapon or in the case where the player's character is performing an avoidance action, virtual-camera correction processing for correcting the orientation of the virtual camera is performed such that a spherical specific range centered on the specific point is contained in a first judgment range (predetermined range) shown in FIG. 12.

Specifically, in the screen on which objects arranged in the virtual 3D space are projected, the first judgment range is set such that the center of the first judgment range becomes the center of the screen. Then, in the case where a conical range connecting the position of the virtual camera and the specific range does not intersect the screen within the first judgment range, the orientation of the virtual camera is corrected such that the conical range intersects the screen within the first judgment range.

Accordingly, in the case where the player's character is performing an attack action using a melee weapon, the enemy character that is an attack target can be displayed at the center of the display area of the display 200 as much as possible, and, in the case where the player's character is performing an avoidance action, the enemy character that is attacking the player's character can be displayed at the center of the display area of the display 200 as much as possible.

Note that, in the case where the player's character is performing an avoidance action, since the movement speed of the player's character is high, if the orientation of the virtual camera is corrected such that the specific range is always contained in the first judgment range, the orientation of the virtual camera is rapidly changed, thereby displaying an even less visible image, in some cases.

Thus, in the case where the player's character is performing an avoidance action, the orientation of the virtual camera is corrected toward the closest position at which the specific range is contained in the first judgment range, within the limit of the correction amount of the orientation of the virtual camera in one frame, such that the orientation of the virtual camera is not rapidly changed. Therefore, in the case where the player's character is performing an avoidance action, the specific range is not contained in the first judgment range, in some cases.

Furthermore, in the case where the player's character is moving, the orientation of the virtual camera is corrected such that the spherical specific range centered on the specific point is contained in a second judgment range (predetermined range) shown in FIG. 12.

Specifically, the second judgment range is set, in the screen, so as to be wider than the first judgment range such that the center of the second judgment range is slightly shifted to the right from the center of the screen. Then, in the case where the conical range connecting the position of the virtual camera and the specific range does not intersect the screen within the second judgment range, the orientation of the virtual camera is corrected such that the conical range intersects the screen within the second judgment range.

Accordingly, in the case where the player's character is moving, the top-priority-target enemy character can be more displayed on the right side of the player's character, which is displayed at a position shifted to the lower left from the center of the display area of the display 200, while the orientation of the virtual camera is corrected at a less frequency on the basis of the specific point, than the case where the player's character is performing an attack action using a melee weapon and the case where the player's character is performing an avoidance action.

Note that the specific point, the specific range, the first judgment range, and the second judgment range, which are shown in FIG. 12, exist in the form of data but are not displayed as images.

Note that, in the case where a large-sized enemy character (not shown) such as a dragon is set as the top-priority target, a cube-shaped specific range that is larger than the above-described spherical specific range is set at an important part of the large-sized enemy character, such as the face, and the orientation of the virtual camera is corrected such that the cube-shaped specific range is contained in the first judgment range or the second judgment range. In this way, the size and the shape of the specific range are different depending on the size and the shape of an enemy character.

Note that, although the specific range of a large-sized enemy character is contained in the first judgment range or the second judgment range, a distal part of the large-sized enemy character is located outside the screen, i.e., outside a display range, and is not displayed on the display 200, in some cases.

Furthermore, in the case where another processing-target enemy character present in the third range, which is centered on the top-priority-target enemy character, is a large-sized enemy character, since the large-sized enemy character is not displayed in some cases just by correcting the orientation of the virtual camera, the position of the virtual camera is corrected so as to be away from the player's character in the direction along the orientation of the virtual camera.

Specifically, the distance between the virtual camera and the player's character, corresponding to the size and the shape of a large-sized enemy character, is defined for each of a plurality of types of large-sized enemy characters, and the position of the virtual camera is corrected such that the distance between the virtual camera and the player's character becomes the distance defined for the corresponding large-sized enemy character.

Furthermore, in the case where the enemy character in the third range is located outside the display range because the distance between the player's character and the top-priority target is short, the position of the virtual camera is corrected so as to be away from the player's character in the direction along the orientation of the virtual camera such that the enemy character in the third range is located inside the display range.

Furthermore, in the case where an enemy character(s) is present, not in the third range, but in a fourth range located behind the virtual camera because the number of processing-target enemy characters is large, the position of the virtual camera is corrected so as to be away from the player's character in the direction along the orientation of the virtual camera such that the enemy character(s) in the fourth range is located inside the display range.

In this way, in this embodiment, even when the player does not perform a virtual-camera input or even when the player does not perform an input for selecting the top-priority target, enemy characters that should be displayed are automatically and appropriately displayed in accordance with the positions, the orientations, and the sizes of a plurality of enemy characters and the player's character.

Accordingly, in this embodiment, when performing a battle with a plurality of enemy characters, the player can concentrate on performing movement inputs, attack inputs, or avoidance inputs and can enjoy the battle with the plurality of enemy characters.

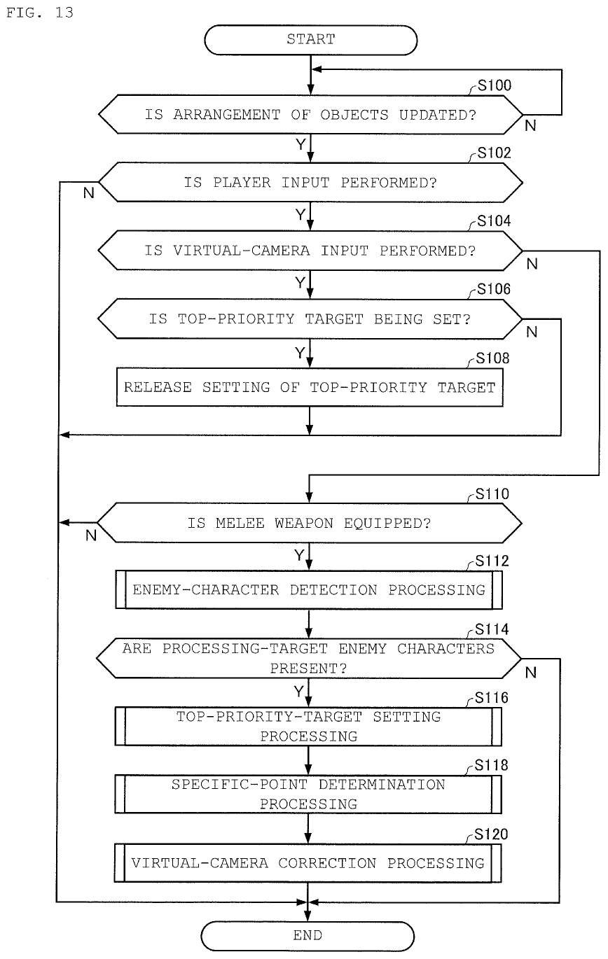

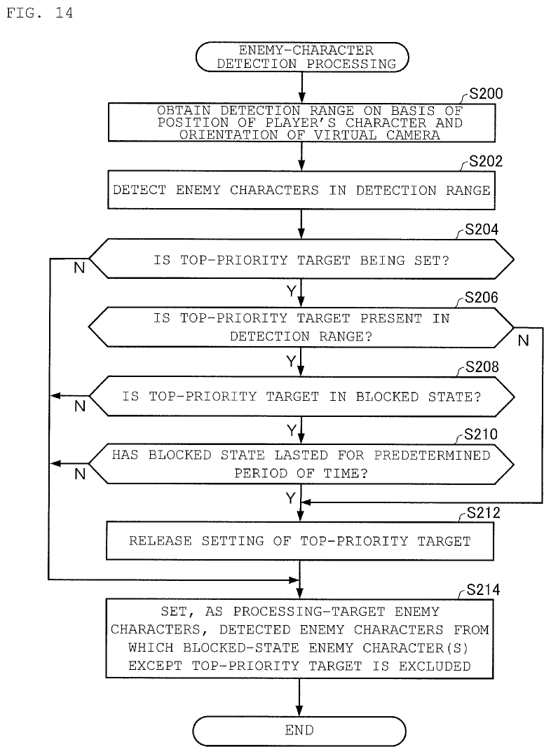

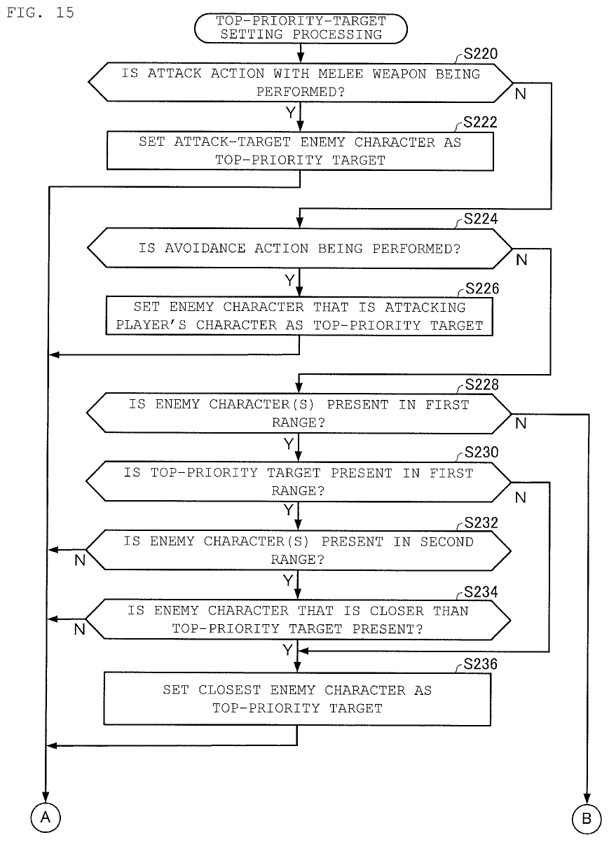

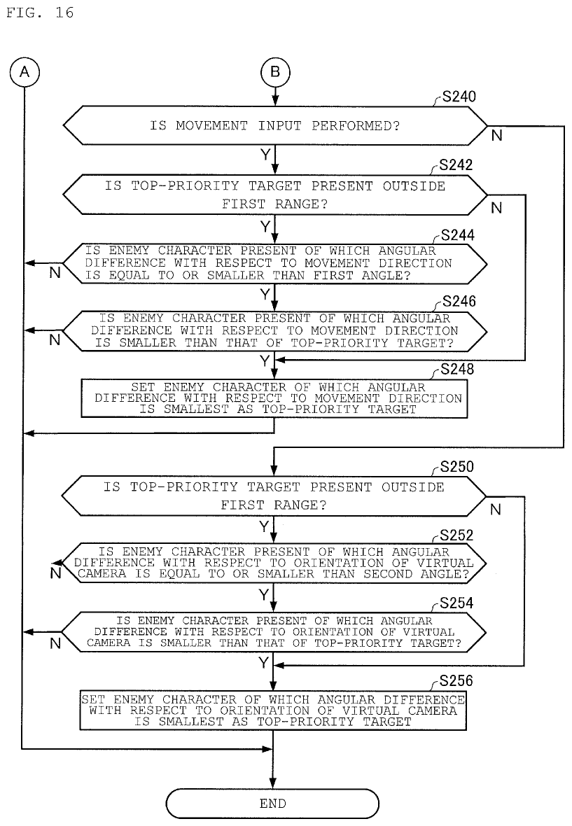

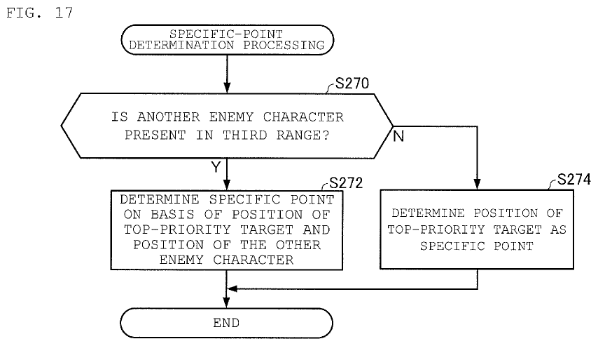

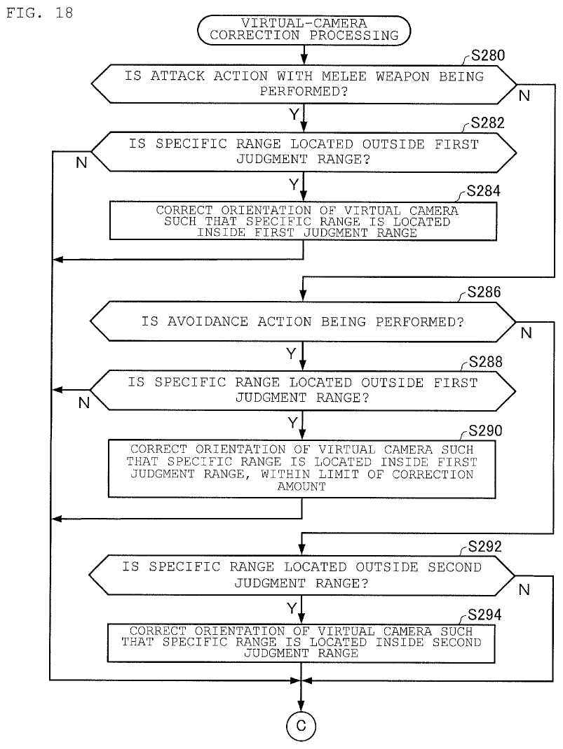

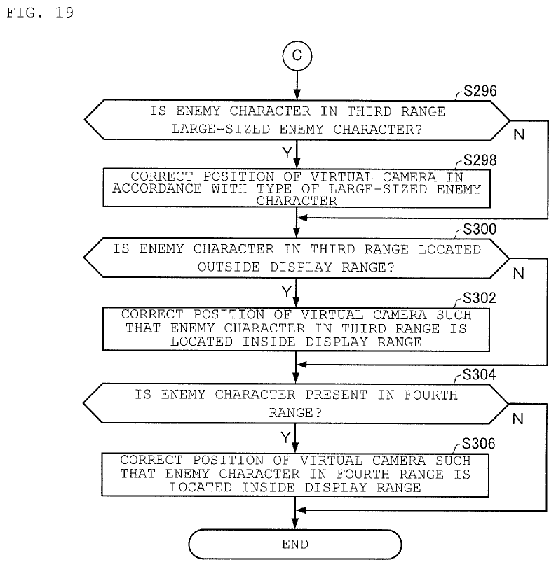

A flow of processing performed in the terminal information processing unit 100 of the terminal device 14 of this embodiment will be described below by using flowcharts of FIGS. 13 to 19. In particular, the enemy-character detection processing shown in FIG. 14 and the top-priority-target setting processing shown in FIGS. 15 and 16 are performed by the top-priority object setting unit 122, the specific-point determination processing shown in FIG. 17 is performed by the specific-point determining unit 124, and the virtual-camera correction processing shown in FIGS. 18 and 19 is performed by the virtual-camera control unit 126.

As shown in FIG. 13, when the frame is updated, and the arrangement of objects is thus updated (Y in Step S100), in the case where a player input is performed (Y in Step S102), and a virtual-camera input is performed (Y in Step S104), it is determined whether the top-priority target is being set (Step S106). In the case where the top-priority target is being set (Y in Step S106), the setting of the top-priority target is released (Step S108), and the processing ends.

On the other hand, in the case where a player input is performed (Y in Step S102), but a virtual-camera input is not performed (N in Step S104), it is determined whether the player's character is equipped with a melee weapon (Step S110). In the case where the player's character is equipped with a melee weapon (Y in Step S110), the enemy-character detection processing is performed (Step S112). In the case where the player's character is not equipped with a melee weapon (N in Step S110), the processing ends.

As a result of the enemy-character detection processing, in the case where processing-target enemy characters are present (Y in Step S114), the top-priority-target setting processing (Step S116), the specific-point determination processing (Step S118), and the virtual-camera correction processing (Step S120) are performed.

As shown in FIG. 14, in the enemy-character detection processing, a detection range is obtained on the basis of the position of the player's character and the orientation of the virtual camera (Step S200), and enemy characters in the obtained detection range are detected (Step S202).

Then, in the case where the top-priority target is being set (Y in Step S204), the top-priority target is present in the detection range (Y in Step S206), the top-priority target is in the blocked state (Y in Step S208), and the blocked state has lasted for a predetermined period of time (Y in Step S210), the setting of the top-priority target is released (Step S212).

Furthermore, in the case where the top-priority target is not present in the detection range (N in Step S206), the setting of the top-priority target is also released (Step S212).

On the other hand, in the case where the top-priority target is not being set (N in Step S204), in the case where the top-priority target is not in the blocked state (N in Step S208), or in the case where the blocked state has not lasted for the predetermined period of time (N in Step S210), the setting of the top-priority target is not released.

Then, the detected enemy characters from which a blocked-state enemy character(s) except the top-priority target is excluded are set as processing-target enemy characters (Step S214).

As shown in FIG. 15, in the top-priority-target setting processing, in the case where the player's character is performing an attack action using a melee weapon (Y in Step S220), the attack-target enemy character is set as the top-priority target (Step S222).

Furthermore, in the case where the player's character is performing an avoidance action (Y in Step S224), the enemy character that is attacking the player's character is set as the top-priority target (Step S226).

Furthermore, in the case where the player's character is not performing an attack action using a melee weapon (N in Step S220), the player's character is not performing an avoidance action (N in Step S224), and the processing-target enemy character(s) is present in the first range (Y in Step S228), it is determined whether the top-priority target is present in the first range (Step S230).

In the case where the top-priority target is present in the first range (Y in Step S230), the processing-target enemy character(s) is present in the second range (Y in Step S232), and the processing-target enemy character that is closer to the player's character than the top-priority target is present (Y in Step S234), the closest processing-target enemy character is set as the top-priority target (Step S236).

On the other hand, in the case where the top-priority target is not present in the first range (N in Step S230), the processing-target enemy character that is closest to the player's character is set as the top-priority target (Step S236).

Furthermore, in the case where the processing-target enemy character(s) is not present in the first range (N in Step S228), as shown in FIG. 16, if a movement input is performed (Y in Step S240), the top-priority target is present outside the first range (Y in Step S242), the processing-target enemy character is present of which the angular difference with respect to the movement direction is equal to or smaller than the first angle (Y in Step S244), and the processing-target enemy character is present of which the angular difference with respect to the movement direction is smaller than that of the top-priority target (Y in Step S246), the processing-target enemy character of which the angular difference with respect to the movement direction is the smallest is set as the top-priority target (Step S248).

Furthermore, in the case where a movement input is not performed (N in Step S240), the top-priority target is present outside the first range (Y in Step S250), the processing-target enemy character is present of which the angular difference with respect to the orientation of the virtual camera is equal to or smaller than the second angle (Y in Step S252), and the processing-target enemy character is present of which the angular difference with respect to the orientation of the virtual camera is smaller than that of the top-priority target (Y in Step S254), the processing-target enemy character of which the angular difference with respect to the orientation of the virtual camera is the smallest is set as the top-priority target (Step S256).

Furthermore, as shown in FIG. 15, in the case where the top-priority target is present in the first range (Y in Step 5230) but the processing-target enemy character is not present in the second range (N in Step S232), or in the case where the processing-target enemy character that is closer to the player's character than the top-priority target is not present (N in Step S234), the setting of the top-priority target in the previous frame is maintained.

Furthermore, as shown in FIG. 16, in the case where the top-priority target is present outside the first range (Y in Step 5242) but no processing-target enemy character is present of which the angular difference with respect to the movement direction is equal to or smaller than the first angle (N in Step S244), in the case where no processing-target enemy character is present of which the angular difference with respect to the movement direction is smaller than that of the top-priority target (N in Step S246), in the case where no processing-target enemy character is present of which the angular difference with respect to the orientation of the virtual camera is equal to or smaller than the second angle (N in Step S252), or, in the case where no processing-target enemy character is present of which the angular difference with respect to the orientation of the virtual camera is smaller than that of the top-priority target (N in Step S254), the setting of the top-priority target in the previous frame is maintained.

As shown in FIG. 17, in the specific-point determination processing, in the case where the other processing-target enemy character is present in the third range centered on the top-priority target (Y in Step S270), a specific point is determined on the basis of the position of the top-priority target and the position of the other processing-target enemy character (Step S272). On the other hand, in the case where the other processing-target enemy character is not present in the third range (N in Step S270), the position of the top-priority target is determined as the specific point (Step S274).

As shown in FIG. 18, in the virtual-camera correction processing, in the case where the player's character is performing an attack action using a melee weapon (Y in Step S280), and the specific range is located outside the first judgment range (Y in Step S282), the orientation of the virtual camera is corrected such that the specific range is located inside the first judgment range (Step S284). On the other hand, in the case where the specific range is not located outside the first judgment range (N in Step S282), the orientation of the virtual camera is not corrected.

Furthermore, in the case where the player's character is performing an avoidance action (Y in Step S286), and the specific range is located outside the first judgment range (Y in Step S288), the orientation of the virtual camera is corrected such that the specific range is located inside the first judgment range, within the limit of the correction amount (Step S290). On the other hand, in the case where the specific range is not located outside the first judgment range (N in Step S288), the orientation of the virtual camera is not corrected.

Furthermore, in the case where the player's character is not performing an attack action using a melee weapon (N in Step S280), the player's character is not performing an avoidance action (N in Step S286), and the specific range is located outside the second judgment range (Y in Step S292), the orientation of the virtual camera is corrected such that the specific range is located inside the second judgment range (Step S294). On the other hand, in the case where the specific range is not located outside the second judgment range (N in Step S292), the orientation of the virtual camera is not corrected.

Furthermore, as shown in FIG. 19, in the case where the enemy character in the third range is a large-sized enemy character (Y in Step S296), the position of the virtual camera is corrected in accordance with the type of the large-sized enemy character (Step S298).

Furthermore, in the case where the position of the enemy character in the third range is outside the display range (Y in Step S300), the position of the virtual camera is corrected such that the position of the enemy character in the third range is inside the display range (Step S302).

Furthermore, in the case where the enemy character is present in the fourth range located at the rear of the virtual camera (Y in Step S304), the position of the virtual camera is corrected such that the enemy character in the fourth range is located inside the display range (Step S306).

### 3. Modification

The present invention is not limited to those in the above-described embodiment and can be modified in various ways, and some modifications will be introduced below. Note that the above-described embodiment and various kinds of methods to be described in the following modifications can be adopted by being appropriately combined, as methods for realizing the present invention.

First, in the above-described embodiment, although a description has been given of an example case in which an image of the player's character viewed from the right rear of the player's character is generated, as shown in FIG. 4, it is also possible to generate an image of the player's character viewed from the upper rear of the player's character. In this case, the player's character is displayed at a position shifted downward from the center of the display area of the display 200, and the second judgment range is set such that the center of the second judgment range is slightly shifted upward from the center of the screen.

Furthermore, in the above-described embodiment, although a description has been given of an example case in which the setting of the top-priority target in the previous frame is maintained if no other processing-target enemy character is present of which the angular difference with respect to the movement direction of the player's character is equal to or smaller than the first angle or if no other processing-target enemy character is present of which the angular difference with respect to the orientation of the virtual camera is equal to or smaller than the second angle, it is also possible that the first angle and the second angle are the same angle or are different angles.

Furthermore, in the above-described embodiment, although a description has been given of an example case in which the detection range, which is shown in FIG. 6, and the first range and the second range, which are shown in FIG. 7, are set so as to be centered on the position of the player's character, and the third range, which is shown in FIG. 10, is set so as to be centered on the position of the top-priority-target enemy character, it is also possible that the detection range, the first range, the second range, and the third range are set so as to be centered on the position of the virtual camera.

Furthermore, in the above-described embodiment, although a description has been given of an example case in which the orientation of the virtual camera is corrected such that the spherical specific range centered on the specific point is contained in the first judgment range or the second judgment range, the ranges being shown in FIG. 12, it is also possible that the orientation of the virtual camera is corrected such that the specific point is contained in the first judgment range or the second judgment range.

Furthermore, in the above-described embodiment, although a description has been given of an example case in which the orientation of the virtual camera is corrected on the basis of the first judgment range in the case where the player's character is performing an attack action using a melee weapon or in the case where the player's character is performing an avoidance action, and the orientation of the virtual camera is corrected on the basis of the second judgment range in the case where the player's character is moving, it is also possible that the orientation of the virtual camera is corrected on the basis of a common judgment range in the case where the player's character is performing an attack action using a melee weapon, in the case where the player's character is performing an avoidance action, and in the case where the player's character is moving, or the orientation of the virtual camera is corrected on the basis of a different judgment range in each of the case where the player's character is performing an attack action using a melee weapon, the case where the player's character is performing an avoidance action, and the case where the player's character is moving.

Furthermore, it is also possible that the position of the virtual camera is corrected such that the specific range or the specific point is contained in the first judgment range or the second judgment range, the orientation of the virtual camera is corrected depending on the type of a large-sized enemy character, or the orientation of the virtual camera is corrected such that the position of an enemy character in the third range is located in the display range. Specifically, at least one of the position and the orientation of the virtual camera may be controlled on the basis of the specific point.

Furthermore, in the case where the number of enemy characters in a predetermined range of the top-priority target is larger than a predetermined number, at least one of the orientation and the position of the virtual camera may be corrected.

Furthermore, in the above-described embodiment, although a description has been given of an example case in which the present invention is applied to action games for solo players, the present invention may be applied to battle games for multiple players, and, in this case, an enemy character may be operable by another player.

Furthermore, in the above-described embodiment, although a description has been given of an example case in which the present invention is applied to action games, the present invention may be applied to various kinds of games from a third person point of view, e.g., sport games such as soccer and basketball, fighting games, and racing games.

Furthermore, in the above-described embodiment, although a description has been given of an example case in which the present invention is applied to a game application for console video game machines, the present invention may be applied to smartphones (information processing devices) or arcade game devices (information processing devices) installed at stores. Then, in the case where the present invention is applied to smartphones or arcade game devices, it is possible that the terminal devices serve as the smartphones or the arcade game devices, and the plurality of terminal devices communicate with the server device, and, in this case, the present invention can be applied to the terminal devices or the server device. Furthermore, the present invention may be applied to a stand-alone game device that is not connected to the server device 12.

What is claimed is:

1. A non-transitory computer-readable information storage medium storing a program for generating an image of a virtual space viewed from a virtual camera, the program causing a computer to function as:
an object control unit for controlling movement of a first object that can be operated by a player and one or a plurality of second objects that cannot be operated by the player, in the virtual space;
a top-priority object setting unit for setting a top-priority second object from among the second object(s) that is present around the first object;
a specific-point determining unit for determining, in the case where the other second object is present around the set top-priority second object, a specific point on the basis of the position of the top-priority second object and the position of the other second object; and
a virtual-camera control unit for controlling at least one of the position and the orientation of the virtual camera on the basis of the determined specific point.

2. The information storage medium according to claim 1, wherein the virtual-camera control unit controls the orientation of the virtual camera such that the specific point is contained in a predetermined range in the image viewed from the virtual camera.

3. The information storage medium according to claim 1, wherein the virtual-camera control unit controls the orientation of the virtual camera on the basis of the type of an action of the first object.

4. The information storage medium according to claim 1, wherein the virtual-camera control unit controls the position of the virtual camera on the basis of at least one of the position of the second object(s), the number of the second objects, and the size of the second object(s).

5. An information processing device for generating an image of a virtual space viewed from a virtual camera, the information processing device comprising:
an object control unit for controlling movement of a first object that can be operated by a player and one or a plurality of second objects that cannot be operated by the player, in the virtual space;
a top-priority object setting unit for setting a top-priority second object from among the second object(s) that is present in a first range set in accordance with the position of the first object;
a specific-point determining unit for determining, in the case where the other second object is present around the set top-priority second object, a specific point on the basis of the position of the top-priority second object and the position of the other second object; and
a virtual-camera control unit for controlling at least one of the position and the orientation of the virtual camera on the basis of the determined specific point.

6. An information processing method for generating an image of a virtual space viewed from a virtual camera, the method being executed by a computer, the method comprising:
controlling movement of a first object that can be operated by a player and one or a plurality of second objects that cannot be operated by the player, in the virtual space;
setting a top-priority second object from among the second object(s) that is present in a first range set in accordance with the position of the first object;
determining, in the case where the other second object is present around the set top-priority second object, a specific point on the basis of the position of the top-priority second object and the position of the other second object; and
controlling at least one of the position and the orientation of the virtual camera on the basis of the determined specific point.
